(19) United States
(12) Patent Application Publication
(10) Pub. No.: US 2026/0103832 A1
(43) Pub. Date: Apr. 16, 2026

(54) BOX VALVES WITH ARRESTORS AND BACKFLOW PREVENTION

(71) Applicant: NIBCO Inc., Elkhart, IN (US)

(72) Inventor: Christopher W. Mason, Granger, IN (US)

(73) Assignee: NIBCO Inc., Elkhart, IN (US)

(21) Appl. No.: 19/354,060

(22) Filed: Oct. 9, 2025

Related U.S. Application Data
(60) Provisional application No. 63/706,774, filed on Oct. 14, 2024.

(51) Int. Cl. D06F 39/08; F16K 5/06; F16K 15/14; F16K 47/02

(52) U.S. Cl. CPC D06F 39/088; F16K 5/06; F16K 15/14; F16K 47/02

(57) ABSTRACT

A washer box valve(s) with water hammer arrestors utilizes union connection fittings and check valve inserts to provide additional backflow protection to the system. The check valve inserts are positioned in coupling members that prevent backflow into the incoming hot and cold water supply lines. The water hammer arrestors are coupled to a valve body that has an inlet, an outlet, and an optional drain port.

### CLAIM OF PRIORITY

The present application claims the priority benefits under the provisions of 35 U.S.C. § 119, basing said claim of priority on related U.S. Provisional Application No. 63/706,774 filed October 14, 2024, which is incorporated in its entirety herein by reference.

### FIELD OF THE INVENTION

The present invention relates to box valves with water hammer arrestors and backflow prevention.

### BACKGROUND OF THE INVENTION

Washing machines can be equipped with solenoid valves that open to permit water flow to the washing machine when a wash cycle is started. These solenoid valves can close quickly causing a water hammer in the water supply. Water hammer arrestors can be placed on the washer box valve connections to minimize this shock. However, solenoid valves can fail causing potential backflow into the main water supply, potentially causing cross-contamination and/or pressure disruption. This is especially an issue in multi-family dwellings, high-rise apartment buildings, hotels, motels, etc. where a main water line may be connected to multiple washing machines or other appliances, such as ice makers. Thus, a plumbing assembly that provides additional backflow prevention would be advantageous.

### SUMMARY OF THE INVENTION

One object of the present invention is a washing machine box assembly. The washing machine box assembly has a drain opening, a hot water opening, and a cold water opening. The washing machine box assembly has a hot water arrestor valve assembly with an inlet, an outlet, a valve member, and an arrestor. The washing machine box assembly has a cold water arrestor valve assembly with an inlet, an outlet, a valve member, and an arrestor. The washing machine box assembly has a hot water coupling member with a check valve insert. The coupling member is coupled to the hot water arrestor valve assembly inlet and a hot water supply line. The washing machine box assembly has a cold water coupling member with a check valve insert. The coupling member is coupled to the cold water arrestor valve assembly inlet and a cold water supply line. The check valve inserts permit water to flow toward the inlets and prevent water from flowing from the inlets to the incoming hot and cold water supply lines.

Another object of the present invention is an arrestor valve assembly. The arrestor valve assembly has a valve body having an inlet and an outlet. The inlet has a flange and a threaded exterior surface. A valve member is positioned in the valve body at the intersection of the inlet and the outlet. The valve member permits the opening and closing of the fluid passageway between the inlet and the outlet. A water arrestor is coupled to the valve body. A coupling member with a flange member, a fitting end, and a threaded internal surface is coupled to said threaded exterior surface of the valve body. A check valve insert is positioned in the fitting end, permitting the flow of water from the fitting end to the valve body.

Yet another object of the present invention is a washing machine box assembly. The washing machine box assembly has a drain opening, a hot water opening, and a cold water opening. The washing machine box assembly has a hot water arrestor valve assembly having an inlet with a flange member, an outlet, a valve member, and an arrestor. The washing machine box assembly has a cold water arrestor valve assembly having an inlet with a flange member, an outlet, a valve member, and an arrestor. The washing machine box assembly has a hot water coupling member with a flange member and a check valve insert. The coupling member is coupled to the hot water arrestor valve assembly inlet and a hot water supply line. The washing machine box assembly has a cold water coupling member with a flange member and a check valve insert. The coupling member is coupled to the cold water arrestor valve assembly inlet and a cold water supply line. The check valve inserts permit water to flow toward the inlets and prevent water from flowing from the inlets to the incoming hot and cold water supply lines.

These and other advantages of the invention will be further understood and appreciated by those skilled in the art by reference to the following written specification, claims, and appended drawings.

### DETAILED DESCRIPTION OF THE PREFERRED EMBODIMENTS

For purposes of description herein, the terms “upper,” “lower,” “right,” “left,” “rear,” “front,” “vertical,” “horizontal,” and derivatives thereof shall relate to the invention as oriented in the attached drawings. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

These and other advantages of the invention will be further understood and appreciated by those skilled in the art by reference to the following written specification, claims, and appended drawings.

### BRIEF DESCRIPTION OF THE DRAWINGS

In the drawings:

FIG. 1 is a front view of a washing machine box assembly;

FIG. 2 is a front cross-sectional view of the coupling member shown in FIG. 1 with a check valve insert;

FIG. 3 is a side cross-sectional view of the coupling member shown in FIG. 2;

FIG. 4 illustrates different fitting ends for the coupling member;

FIG. 5 shows a partial front cross-sectional view of another embodiment of an arrestor valve assembly;

FIG. 6 is a front view of the arrestor valve assembly shown in FIG. 5;

FIG. 7 is a rotated side view of the arrestor valve assembly shown in FIG. 5;

FIG. 8 is a side cross-sectional view of another arrestor valve assembly;

FIG. 9 is a rotated side view of the arrestor valve assembly shown in FIG. 8;

FIG. 10 is another embodiment of an arrestor valve assembly;

FIG. 11 is a side cross-sectional view of the arrestor valve assembly shown in FIG. 10; and

FIG. 12 is a side view of the arrestor valve assembly shown in FIG. 10.

### DETAILED DESCRIPTION OF THE PREFERRED EMBODIMENTS

For purposes of description herein, the terms “upper,” “lower,” “right,” “left,” “rear,” “front,” “vertical,” “horizontal,” and derivatives thereof shall relate to the invention as oriented in the attached drawings. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The detailed embodiments of the present invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representative basis for teaching one skilled in the art to variously employ the present invention and virtually in an appropriately detailed embodiment.

Reference numeral 2 illustrates a box valve assembly. The box valve assembly 2 has a hot water inlet opening, a cold water inlet opening, and a drain opening 80 that is coupled to drain 82.

A valve assembly 4 can be used as both the hot water and cold water supply in the box valve assembly 2 for an associated appliance, such as a washing machine. The valve assembly 4 includes an inlet 12 and an outlet 14. A valve member includes a ball 10 that can be rotated by a handle 8. The ball 10 is illustrated as being at the intersection of the fluid passageways of the inlet 12 and outlet 14. The valve assembly 4 includes a flange member 17 that can be positioned against an inside lower surface 19 of the box valve assembly 2. A water arrestor 6 is coupled to the valve assembly 4 in the illustrated embodiments. The water arrestor 6 could be integrally formed with the valve assembly 4.

Coupling member 20 includes a fitting end 40 and a flange member 38. The flange member 38 can be integrally formed on the coupling member 20 or can be a separate component. The flange member 38 is positioned against the outside lower surface 21 of the box valve assembly 2. The flange members 17, 38 operate to secure the valve assembly 4 in the box valve assembly 2 and can be used to prevent movement of the valve assembly 4. Thus, the valve assembly 4 can be rotated to the desired position/orientation, and the flange member 38 will secure the valve assembly 4 in that position by the contact of the flange member 38 on the outside lower surface 21 if the flange member 17 is in contact with the inside lower surface 19.

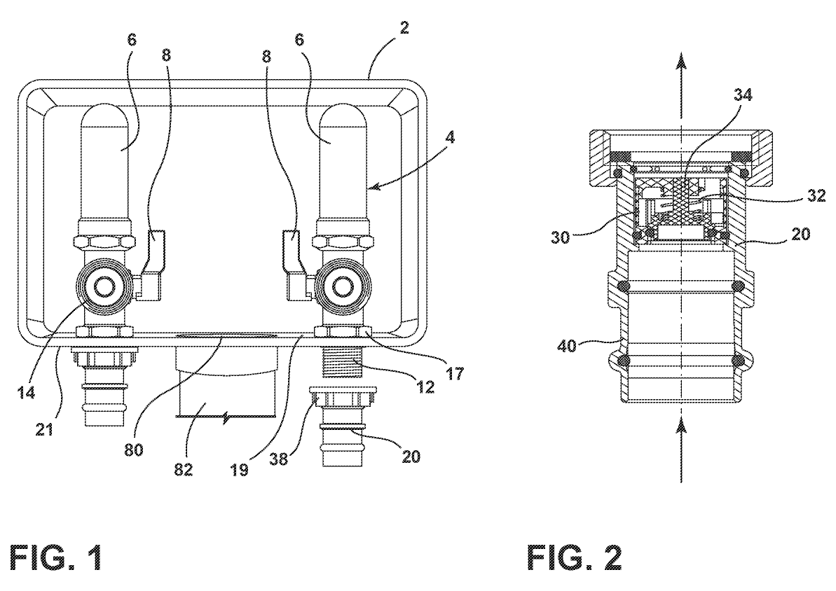

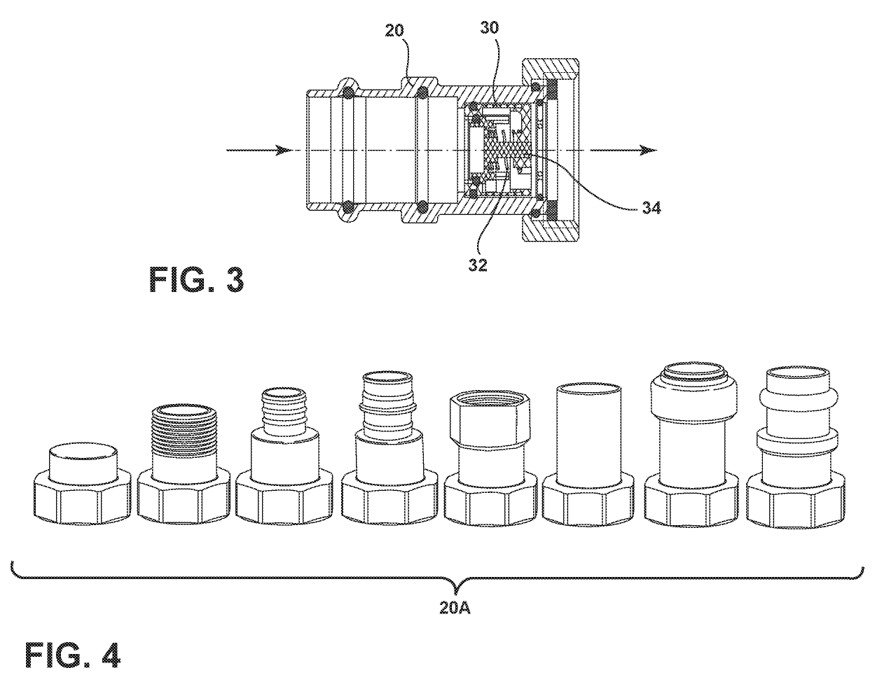

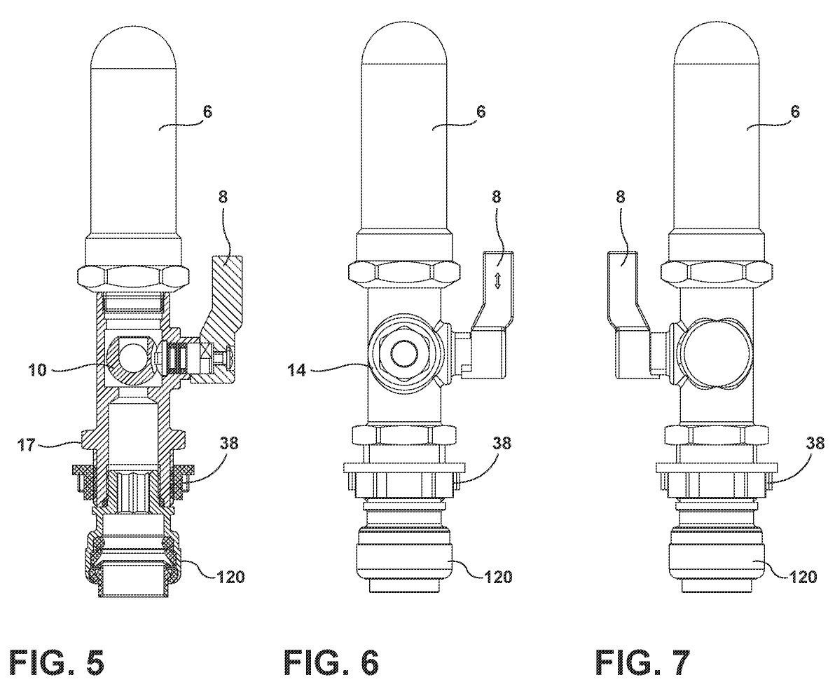

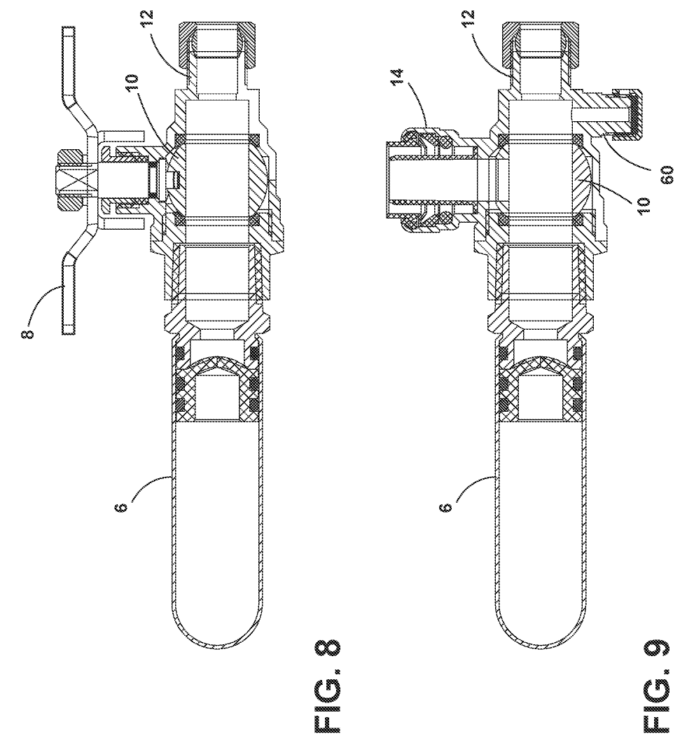

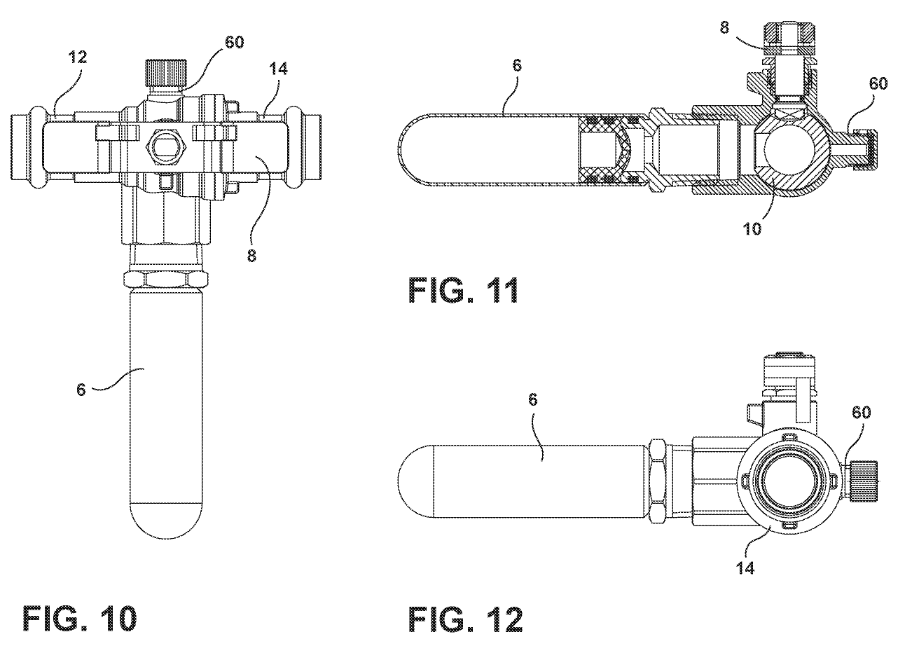

The coupling member 20 includes a threaded surface that couples to the threaded extension of the inlet 12. While the engagement of the coupling member 20 to the inlet 12 is illustrated as a threaded coupling in FIG. 1, other coupling arrangements can be used.

The coupling member 20 is illustrated as having a press fitting end 40. However, numerous other fitting ends can be used, as illustrated in FIG. 4, including, but not limited to, male iron pipe (MIP), PEX, PEK, female iron pipe (FIP), sweat, push-to-connect, and press. The fitting end 40 of the coupling member 20 is coupled to an incoming water supply (cold and/or hot).

A check valve insert 30 is positioned inside the coupling member 20. The check valve insert 30 is used to prevent backflow from the appliance and valve assembly 4 to the incoming water supply (hot and/or cold). The check valve insert 30 includes a spring member 32 and a diaphragm 34. The diaphragm 34 flexes open when the pressure on the upside is greater than the pressure on the downside and closes, when the pressure is equalized or lowered, due to the pressure of the spring member 32.

The valve assembly 4 can include a drain port 60 as illustrated in FIG. 9 and FIG. 10. The drain port 60 can be a bleeder drain valve or a drain valve that can couple to a hose for draining. The drain port 60 can be positioned in between the inlet 12 and outlet 14. The drain port 60 can also be positioned opposite the water arrestor 6.

The valve assembly 4 can include a three-way ball valve. The ball 10 can include three openings that allow for multiple pathway options. In particular, when the valve assembly 4 includes a drain port 60, the three-way ball valve can permit selective flow between the inlet 12, the outlet 14, and the port 60. The closed section of the ball 10 can be oriented toward one of the inlet 12, the outlet 14, or the drain port 60. The closed section of the ball 10 could also end up being oriented away from all three of the inlet 12, outlet 14, and drain port 60.

In the foregoing description, it will be readily appreciated by those skilled in the art that modifications may be made to the invention without departing from the concepts disclosed herein. Such modifications are to be considered as included in the following claims, unless these claims by their language expressly state otherwise.

It will be understood by one having ordinary skill in the art that construction of the present disclosure and other components is not limited to any specific material. Other exemplary embodiments of the disclosure disclosed herein may be formed from a wide variety of materials, unless described otherwise herein.

For purposes of this disclosure, the term “coupled” or “operably coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the term “connected” or “operably connected” (in all of its forms, connect, connecting, connected, etc.) generally means that one component functions with respect to another component, even if there are other components located between the first and second components, and the term “operable” defines a functional relationship between components.

It is also important to note that the construction and arrangement of the elements of the present disclosure as shown in the exemplary embodiments is illustrative only. Although only a few embodiments of the present innovations have been described in detail in this disclosure, those skilled in the art who review this disclosure will readily appreciate that, unless otherwise described, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating positions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A washing machine box assembly comprising:
a washing machine box with a drain opening, a hot water opening, and a cold water opening;
a hot water arrestor valve assembly having an inlet, an outlet, a valve member, and an arrestor;
a cold water arrestor valve assembly having an inlet, an outlet, a valve member, and an arrestor;
a hot water coupling member having a check valve insert, said coupling member coupled to said hot water arrestor valve assembly inlet and a hot water supply line;
a cold water coupling member having a check valve insert, said coupling member coupled to said cold water arrestor valve assembly inlet and a cold water supply line; and
wherein said check valve inserts permit water to flow toward said inlets and prevent water from flowing from said inlets to said incoming hot and cold water supply lines.

2. The washing machine box assembly of claim 1, wherein said hot water inlet and said cold water inlet have threaded extensions that extend beyond said hot water opening and said cold water opening in said washing machine box, respectively.

3. The washing machine box assembly of claim 1, wherein said hot water coupling member and said cold water coupling member have flange sections that abut said hot water opening and said cold water opening in said washing machine box, respectively.

4. The washing machine box assembly of claim 1, wherein said valve members include a ball positioned at the intersection of the inlets and outlets.

5. The washing machine box assembly of claim 1, wherein said hot water arrestor valve assembly includes a drain port.

6. The washing machine box assembly of claim 5, wherein the valve member of said hot water arrestor valve assembly is a three-way ball valve.

7. The washing machine box assembly of claim 5, wherein said drain port is positioned in between said inlet and said outlet.

8. An arrestor valve assembly, comprising:
a valve body having an inlet and an outlet, said inlet having a flange and a threaded exterior surface;
a valve member positioned in said valve body at the intersection of the inlet and the outlet, said valve member permitting the opening and closing of the fluid passageway between said inlet and said outlet;
a water arrestor coupled to said valve body;
a coupling member with a flange member, a fitting end, and a threaded internal surface coupled to said threaded exterior surface of said valve body; and
a check valve insert positioned in said fitting end, permitting the flow of water from the fitting end to said valve body.

9. The arrestor valve assembly of claim 8, wherein said valve body includers a drain port.

10. The arrestor valve assembly of claim 9, wherein said valve member is a three-way ball valve.

11. The arrestor valve assembly of claim 9, wherein said drain port is positioned in between said inlet and said outlet.

12. The arrestor valve assembly of claim 11, wherein said drain port is a bleeder drain valve positioned opposite said water arrestor.

13. The arrestor valve assembly of claim 8, wherein said inlet is positioned perpendicular to said outlet on said valve body.

14. A washing machine box assembly comprising:
a washing machine box with a drain opening, a hot water opening, and a cold water opening;
a hot water arrestor valve assembly having an inlet with a flange member, an outlet, a valve member, and an arrestor;
a cold water arrestor valve assembly having an inlet with a flange member, an outlet, a valve member, and an arrestor;
a hot water coupling member having a flange member and a check valve insert, said coupling member coupled to said hot water arrestor valve assembly inlet and a hot water supply line;
a cold water coupling member having a flange member and a check valve insert, said coupling member coupled to said cold water arrestor valve assembly inlet and a cold water supply line; and
wherein said check valve inserts permit water to flow toward said inlets and prevent water from flowing from said inlets to said incoming hot and cold water supply lines.

15. The washing machine box assembly of claim 14, wherein said hot water inlet and said cold water inlet have threaded extensions that extend beyond said hot water opening and said cold water openings, respectively.

16. The washing machine box assembly of claim 15, wherein said hot water coupling member and said cold water coupling member have threaded sections that couple to said threaded extensions of said inlets of said hot water and said cold water arrestor valve assemblies.

17. The washing machine box assembly of claim 14, wherein said valve members include a ball positioned at the intersection of the inlets and outlets.

18. The washing machine box assembly of claim 14, wherein said hot water arrestor valve assembly includes a drain port.

19. The washing machine box assembly of claim 18, wherein the valve member of said hot water arrestor valve assembly is a three-way ball valve.

20. The washing machine box assembly of claim 18, wherein said drain port is positioned in between said inlet and said outlet.
